(19) United States
(12) Patent Application Publication
(10) Pub. No.: US 2004/0026101 A1
(43) Pub. Date: Feb. 12, 2004

(54) Parallel two-core shielding wire and method for producing the same

(76) Inventor: Yuji Ochi, Tochigi (JP)

Correspondence Address: SMITH, GAMBRELL & RUSSELL, LLP, 1850 M STREET, N.W., SUITE 800, WASHINGTON, DC, 20036, US

(21) Appl. No.: 10/433,963

(22) PCT Filed: Mar. 22, 2002
(86) PCT No.: PCT/JP02/02763

(30) Foreign Application Priority Data
Mar. 23, 2001 (JP) 2001-085496

(51) Int. Cl. H01B 7/29

(52) U.S. Cl. 174/36

(57) ABSTRACT

A shielded electric wire so designed as to increase the manufacturing linear speed with a shielding conductor formed by winding a metal foil tape.

More specifically, a parallel two-core type shielded electric wire is provided such that at least one drain conductor 15 is attached parallel to a pair of insulated wires 11 arranged in parallel; a metal foil tape is wound on the insulated wires 11 and the drain conductor 15 collectively to form a shielding conductor 14; and the outer peripheral portion of the shielding conductor 14 is covered with a jacket 16. The metal foil tape is wound (by cigarette winding) in a condition that it is attached parallel to the insulated wires and the drain conductor.

### TECHNICAL FIELD

The present invention relates to shielded electric wires for use in transmitting digital signals and more particularly to a parallel two-core type shielded electric wire and a cable using the wires.

### BACKGROUND ART

With the growth of, and expansion of demand for, digital data communication in recent years, shielded electric wires have come be widely used in signal transmission through various kinds of electronic information equipment including intra-office and private electronic equipment. Parallel two-core type shielded electric wires are normally employed for communicating purposes and a plurality of such shielded electric wires are often formed into a multicore cable. The shielded electric wire is thicker in diameter and more expensive than any ordinary unshielded electric wire because a shielding conductor is provided in the former. However, there increasingly develops a demand for finer shielded electric wires in order to cope with high-density packaging resulting from a desire for saving space of wiring and reducing the size of electronic equipment and a demand for cost of electronic equipment.

The parallel two-core type shielded electric wire can be made by covering a pair of single-core shielded electric wires with a common jacket, the single-core shielded electric wire being prepared by forming a shielding conductor with a plurality of leads spirally wound or intertwined on an insulated wires having an inner conductor covered with the insulating material. In case where a shielded structure with the intertwined leads or the like is used, however, there is a limit to reduce the diameter of the wire because the intertwined wire material is needed to be thick to a certain extent and this makes the shielded structure unfit for realizing high-density packaging.

Therefore, it has been known to reduce the diameter of such a wire by forming the shielding conductor with a metal foil tape wound thereon. More specifically, three kinds of structures are generally employed as shown in FIG. 4. In FIG. 4, reference number 1 denotes an insulated wire; 2, an inner conductor; 3, an insulating material; 4, a shielding conductor; 5, a drain conductor; and 6, a jacket. In this case, the insulated wire 1 is formed by covering the inner conductors 2 with the insulating material 3.

The shielded electric wire shown in FIG. 4(A) is formed through the steps of a) attaching the terminal-connecting drain conductor 5 parallel to the lateral side of one of the pair of insulated wires 1 arranged in parallel, b) winding the insulated wires 1 and the drain conductor 5 collectively with the shielding conductor 4 and c) covering the outer peripheral portion of the shielding conductor 4 with the jacket 6. What is shown in FIG. 4(B) is formed through the steps of a) putting the pair of insulated wires 1 arranged in parallel and attaching the drain conductor 5 parallel to the lateral sides of both insulated wires and b) like what is shown in FIG. 4(A), forming the shielding conductor 4 and the jacket 6. Moreover, what is shown in FIG. 4(C) is formed through the steps of a) putting the pair of insulated wires 1 arranged in parallel and attaching the drain conductor 5 in the central portion where both insulated wires are brought into contact with each other so that the drain conductor 5 is attached parallel to the insulated wires and b) like what is shown in FIG. 4(A), forming the shielding conductor 4 and the jacket 6.

As shown in FIG. 5(A), further, numbers of parallel two-core type shielded electric wires in FIGS. 4(A)-(C) are bundled into a circular multicore cable or as shown in FIG. 5(B), a ribbon-shaped multicore cable before being used in intra-office and private wiring. In the case of wiring within electronic equipment, an electrical connector is connected to such a cable for use as a harness.

The shielding conductor 4 of the shielded electric wire in FIGS. 4(A)-(C) is as shown in FIG. 6 formed by attaching the drain conductor 5 parallel to the pair of insulated wires 1, spirally winding a metal foil tape 7 (hereinafter called the spiral winding) to integrate these parts and covering the combination with the jacket 6. The metal foil tape 7 for forming the shielding conductor 4 is prepared by depositing or pasting a conductor foil 7a of aluminum or copper excellent in conductivity onto a base 7b of a polyester plastic film so as to build a laminated structure.

The metal foil tape 7 is wound with the conductor foil 7a set inside so that the conductor foil surface and the drain conductor 5 are brought into contact with each other. When the metal foil tape 7 is wound, the manufacturing linear speed is determined by a tape winding pitch and the number of winding revolutions. With the tape winding pitch being set at 15 mm and the number of winding revolutions set at 200 rpm, for example, the linear speed is 3 m/min. The manufacture of shielded electric wires at this linear speed results in not so high production efficiency, thus causing an increase in the shielded electric wire cost.

An object of the invention made in view of the situation above is to provide a shielded electric wire so designed as to increase the manufacturing linear speed by forming a shielding conductor with a metal foil tape wound thereon and a method of producing the same.

Another object of the invention is to provide a multicore cable using the shielded electric wires.

### DISCLOSURE OF THE INVENTION

The object of the invention can be accomplished as follows:

1. A parallel two-core type shielded electric wire wherein at least one drain conductor is attached parallel to a pair of insulated wires arranged in parallel; a metal foil tape is wound on the insulated wires and the drain conductor collectively to form a shielding conductor; and an outer peripheral portion of the shielding conductor is covered with a jacket, characterized in that the metal foil tape is wound (by cigarette winding) in a condition that it is attached parallel to the insulated wires and the drain conductor.

2. A parallel two-core type shielded electric wire as described in 1, characterized in that an adhesive agent is applied to one side opposite to the conductor foil side of the metal foil tape, so that the metal foil tape is made integral with the jacket by bonding.

3. A method of producing a parallel two-core type shielded electric wire, comprises the steps of: arranging a pair of insulated wires in parallel, attaching at least one drain conductor parallel to the insulated wires; winding a metal foil tape on the insulated wires and the drain conductor collectively to form a shielding conductor; and covering an outer peripheral portion of the shielding conductor with a jacket, characterized in that the metal foil tape is wound (by cigarette winding) in a condition that it is attached parallel to the insulated wires and the drain conductor.

4. A method of producing a parallel two-core type shielded electric wire as described in 3, characterized in that a hot-melt adhesive agent is applied to one side opposite to the conductor foil side of the metal foil tape and wherein the metal foil tape is bonded integrally to the jacket by heat produced when the jacket is used to cover the wire.

5. A cable formed with a plurality of parallel two-core type shielded electric wires bundled together into a multicore cable, the parallel two-core type shielded electric wire being formed such that at least one drain conductor is attached parallel to a pair of insulated wires arranged in parallel; a metal foil tape is wound on the insulated wires and the drain conductor collectively to form a shielding conductor; and an outer peripheral portion of the shielding conductor is covered with a jacket, characterized in that the metal foil tape is wound in a condition that it is attached parallel to the insulated wires and the drain conductor.

6. A cable as described in 5, characterized in that an adhesive agent is applied to one side opposite to the conductor foil side of the metal foil tape, so that the metal foil tape is made integral with the jacket by bonding.

7. A method of producing a cable formed with a plurality of parallel two-core type shielded electric wires bundled together into a multicore cable, the parallel two-core type shielded electric wire being formed such that at least one drain conductor is attached parallel to a pair of insulated wires arranged in parallel; a metal foil tape is wound on the insulated wires and the drain conductor collectively to form a shielding conductor; and an outer peripheral portion of the shielding conductor is covered with a jacket, characterized in that the metal foil tape is wound in a condition that it is attached parallel to the insulated wires and the drain conductor.

8. A method of producing a cable as described in 7, characterized in that a hot-melt adhesive agent is applied to one side opposite to the conductor foil side of the metal foil tape and wherein the metal foil tape is bonded integrally to the jacket by heat produced when the jacket is used to cover the wire.

### BRIEF DESCRIPTION OF THE DRAWINGS

FIG. 1 shows views explanatory of an embodiment of the invention.

FIG. 2 shows views illustrating the structure of a shielded electric wire embodying the invention.

FIG. 3 shows a schematic view illustrating a method of producing the shielded electric wire according to the invention.

FIG. 4 shows views illustrating the structure of conventional shielded electric wires.

FIG. 5 shows views illustrating conventional shielded cables.

FIG. 6 shows a view illustrating a method of forming a conventional shielding conductor.

In the drawings, reference number 11 denotes an insulated wire; 12, an inner conductor; 13, insulating material; 14, shielding conductor; 15, drain conductor; 16, jacket; 17, metal foil tape; 18, forming die; 19, coating forming die.

### BEST MODE FOR CARRYING OUT THE INVENTION

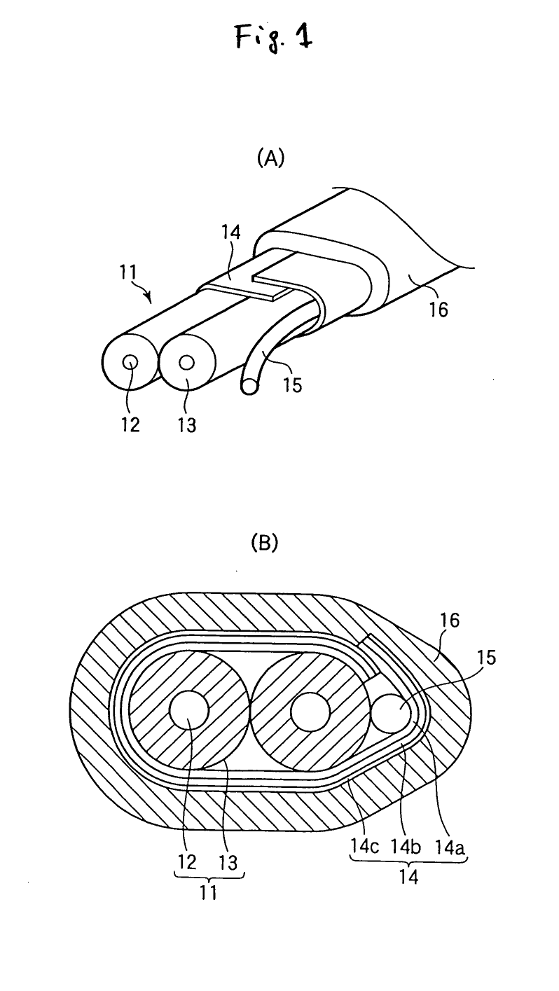

An embodiment of the invention will now be described by reference to FIG. 1. FIG. 1(A) is a perspective view of a shielded electric wire and FIG. 1(B), an enlarged sectional view thereof according to the invention. In FIG. 1, reference numeral 11 denotes an insulated wire; 12, an inner conductor; 13, an insulating material; 14, a shielding conductor; 15, a drain conductor; and 16, a jacket. In the drawings, the shielding conductor 14 has been drawn enlarged so as to make it clearly understandable.

A parallel two-core type shielded electric wire according to the invention is formed through the steps of a) putting a pair of insulated wires 11 arranged in parallel with the inner conductors 12 insulated with the respective insulating materials 13, b) attaching the drain conductor 15 parallel to the lateral side of one of the pair of insulated wires 11, c) winding the insulated wires 11 and the drain conductor 15 collectively with the shielding conductor 14 and d) covering the outer peripheral portion of the shielding conductor 14 with the jacket 16. The shielding conductor 14 is formed by winding (hereinafter called the cigarette winding) a metal foil tape prepared by laminating conductor foil 14a onto a plastic base 14b such as a plastic film in a condition that that it is attached parallel to the insulated wires and the drain conductor.

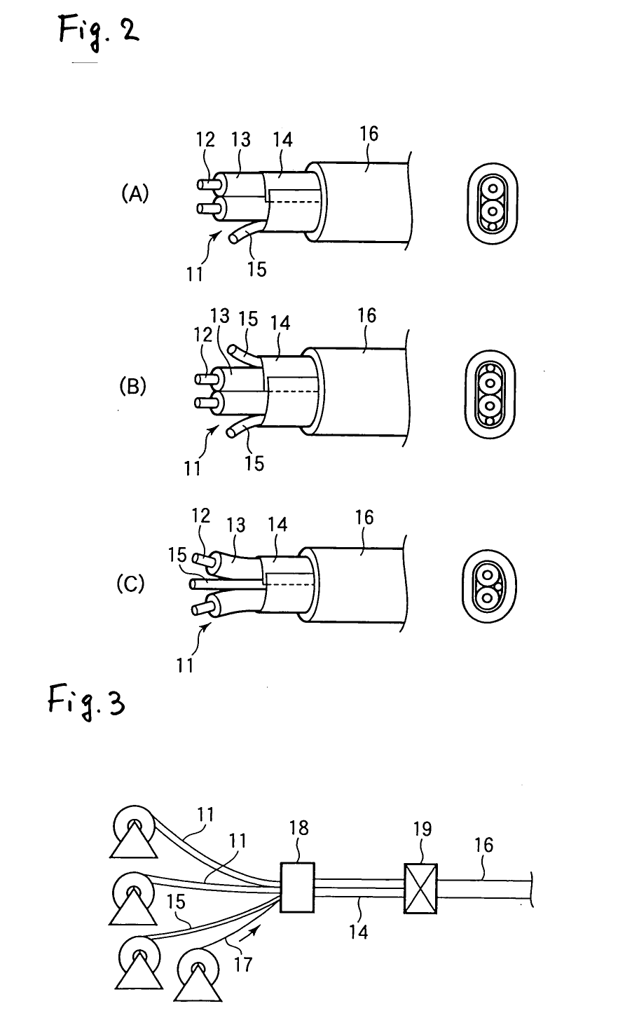

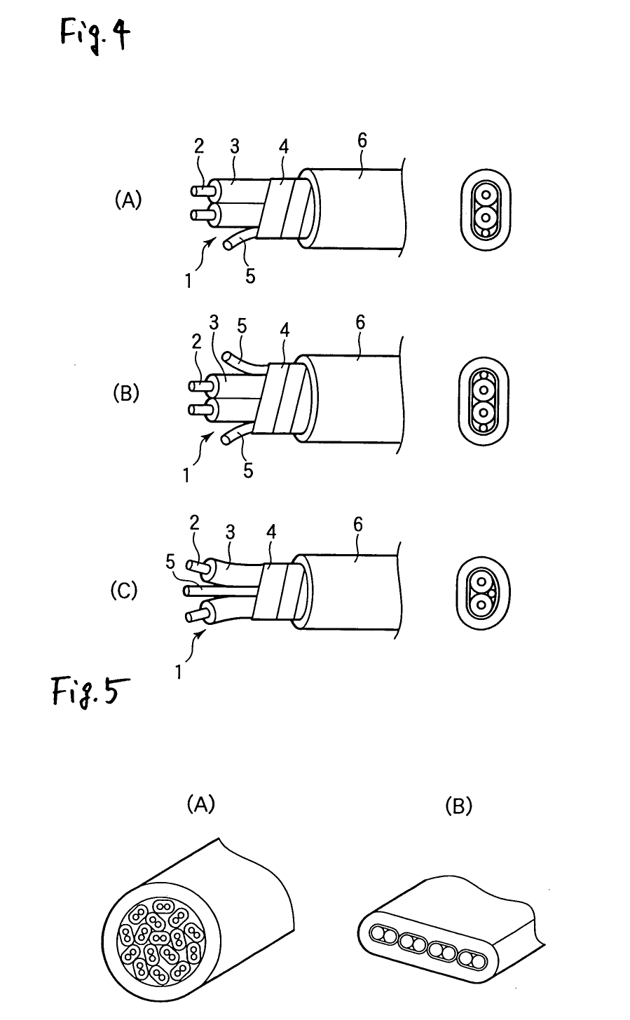

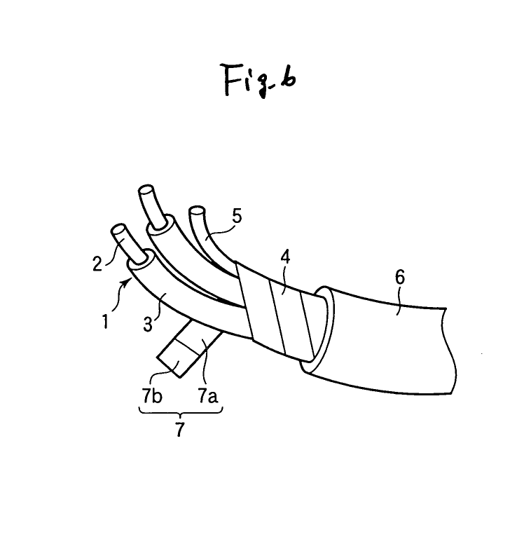

FIG. 2 shows parallel two-core type shielded electric wires embodying the invention. A parallel two-core type shielded electric wire of FIG. 2(A) is formed through the steps of a) attaching the drain conductor 15 parallel to the lateral side of one of the pair of insulated wires 11 that are arranged in parallel, b) winding the insulated wires 1 and the drain conductor 5 collectively with the shielding conductor 14 and c) covering the outer peripheral portion of the shielding conductor 14 with the jacket 16. A parallel two-core type shielded electric wire of FIG. 2(B) is formed through the steps of a) putting the pair of insulated wires 11 arranged in parallel and attaching the drain conductor 15 parallel to the lateral sides of both insulated wires and b) like what is shown in FIG. 2(A), forming the shielding conductor 14 and the jacket 16. Moreover, a parallel two-core type shielded electric wire of FIG. 2(C) is formed through the steps of a) putting the pair of insulated wires 11 arranged in parallel and attaching the drain conductor 15 in the central portion where both insulated wires are brought into contact with each other so that the drain conductor 15 is attached parallel to the insulated wirers and b) like what is shown in FIG. 2(A), forming the shielding conductor 14 and the jacket 16.

The metal foil tape forming the shielding conductor 14 is wound with the conductor foil 14a set inside so that electrical connection is formed as the metal foil tape is kept in contact with the drain conductor 15 attached parallel to the lateral side of the insulated wire 11 over the whole length of the metal foil tape. When the metal foil tape is attached thereto by the cigarette winding (i.e., wound like a cigarette with the metal foil tape attached parallel to the insulated wires and the drain conductor), its side edge portions are overlapped so as to fixedly hold the pair of insulated wires 11 and the drain conductor 15 according to an arrangement by using an adhesive agent. Moreover, use can be made of a base surface coated with an adhesive agent 14c, the base surface being formed opposite to the side where the conductor foil 14a of the metal foil tape is provided. In case where the adhesive agent 14c is employed, it is utilizable for adhering the wrapping portions of the cigarette winding to each other as well as combining the jacket 16 and the shielding conductor 14 together thereby.

A solid wire or stranded wires of electrically good conductors such as aluminum or copper may be used to form each inner conductor 12. The conductor surface may also be plated with tin or silver. In case where the inner conductor 12 is used for a high-frequency line, it is preferably plated with a low-resistance conductive material as the current becomes biased toward the conductor surface because of the skin effect. Any kind of electrical insulating material such as highly foamable polyethylene may be used for the insulating material 13.

The metal foil tape for forming the shielding conductor 14 is formed by pasting or depositing conductor foil of electrically conductor such as copper onto one side of base 14b formed of a plastic film such as a polyethylene terephthalate (PET) film. Moreover, the adhesive agent 14c applied to the side of the base opposite to the conductor foil 14a is preferably a hot-melt adhesive that melts and produces adhesion by heat at the time the jacket 16 is subjected to extrusion coating.

The width of the metal foil tape is selected with approximately [πd+2d+eN+1 mm] as a target where d=diameter of the insulating material 13 and e=diameter of the drain conductor 15. In this case, N is set at [2] in the case of FIG. 2(A), [4] in the case of FIG. 2(B) and [0] in the case of FIG. 2(C). Although FIG. 1(B) shows the enlarged shielding conductor 14, the conductor foil 14a for use is as thin as 7-9 μm, for example, and 15-21 μm in total inclusive of the adhesive agent, so that the shielding conductor is easy to form.

The drain conductor 15 is made of the same material as that of the inner conductor 12; namely, a solid wire or stranded wires of electrically good conductors such as aluminum or copper. Moreover, the thickness of the drain conductor 15 may be substantially the same as that of the inner conductor 12. The drain conductor 15 is fixedly held by the shielding conductor 14 formed by the cigarette winding on the outer surface of the insulating material 13 to ensure that the drain conductor 15 is brought into contact with the conductor foil 14a uniformly over the whole length thereof. Therefore, the drain conductor forms the good electrical connection. The thin shielding conductor 14 in the form of foil can be grounded to a grounding terminal for certain via the drain conductor 15.

The jacket 16 is formed by an extrusion-coating thermoplastic resin such as polyethylene, polyvinyl chloride, fluoroplastic and the like. In case where an adhesive agent is applied to the outer surface of the shielding conductor 14, the jacket 16 is made to integrally adhere to the shielding conductor 14 by the adhesive agent, so that the mechanical strength of the shielding conductor 14 is reinforced. Consequently, the shielding conductor 14 is prevented from being ruptured when the wire is bent. When end portion of the jacket 16 is removed for the purpose of connecting terminals, the shielding conductor 14 is removed at the same time and this facilitates the terminal processing.

By the use of the parallel two-core type shielded electric wires of FIGS. 2(A)-(C), circular and ribbon-shaped multicore cables can be formed by bundling a plurality of parallel two-core type shielded electric wires together as shown in FIG. 5.

The diameters of cables are also made reducible by forming such cables in this way.

A method of producing shielded electric wires and a cable using the wires according to the invention by reference to FIG. 3. In FIG. 3, reference numeral 11 denotes an insulated wire; 14, a shielding conductor; 15, a drain conductor; 16, a jacket; 17, a metal foil tape; 18, a forming die; and 19, a coating forming die. Each insulated wire is formed by covering the inner conductor 12 with an insulating material 13 and a pair of insulated wires 11 are supplied by letting out the wires from a winding drum. The drain conductor 15 and the metal foil tape 17 are similar to those described in FIG. 1 and let out from different winding drums, respectively.

The insulated wires 11, the drain conductor 15 and the metal foil tape 17 are integrated by the forming die 18. The metal foil tape 17 is wound by the cigarette winding with the conductor foil surface set inside on the insulated wires 11 and the drain conductor 15 collectively. At this time, the side edge portions of the metal foil tape 17 are overlapped in a wound condition with the adhesive agent applied to the outer surface of the metal foil tape. After the shielding conductor 14 is formed by winding the metal foil tape 17, the jacket 16 is subjected to extrusion-coating by the coating forming die 19. The manufacturing linear speed in a specific example is 40 m/min, which is several times higher than what is usual in the case of the conventional spiral winding ranging from 2-3 m/min. Thus, productivity is increased at lower cost.

When the jacket 16 is combined by the use of the adhesive agent on the outer surface of the metal foil tape 17, holding the forming of the shielding conductor 14 and reinforcing the mechanical strength are smoothly conducted. When the jacket 16 is removed, moreover, the jacket 16 together with the shielding conductor 14 can simultaneously be removed, so that workability becomes improvable when the terminal processing as well as high-density packaging is performed.

In case where a plurality of shielded electric wires are bundled into a cable and manufactured according to the procedure mentioned above, cable productivity is improvable and a lower production cost is attainable.

Although a detailed description has been given of the specific embodiment of the invention, it is believed obvious for those skilled in the art that various modifications and variations of the invention are possible without departing from the spirit and scope thereof.

The invention is based on Japanese Patent Application dated Mar. 23, 2001 (No. 2001-085496) and the contents thereof are taken in this specification as a reference.

<Industrial Applicability>

As is obvious from the description above, according to the invention, it is possible to reduce the diameter of the shielded electric wire by forming the shielding conductor through the cigarette winding, to increase productivity and to lower the production cost. As the jacket is integrally formed with the shielding conductor by the use of the adhesive agent, workability is improvable while the reinforcement of the strength of the shielded electric wire and easy terminal processing are feasible. When the plurality of shielded electric wires are bundled into a multicore cable, the diameter of the cable is reducible and this results in not only improving productivity but also lowering the production cost.

1. A parallel two-core type shielded electric wire wherein at least one drain conductor is attached parallel to a pair of insulated wires arranged in parallel; a metal foil tape is wound on said insulated wires and said drain conductor collectively to form a shielding conductor; and an outer peripheral portion of said shielding conductor is covered with a jacket, characterized in that said metal foil tape is wound in a condition that it is attached parallel to the insulated wires and the drain conductor.

2. A parallel two-core type shielded electric wire as claimed in claim 1, characterized in that an adhesive agent is applied to one side opposite to the conductor foil side of said metal foil tape, so that said metal foil tape is made integral with said jacket by bonding.

3. A method of producing a parallel two-core type shielded electric wire, comprising the steps of: arranging a pair of insulated wires in parallel, attaching at least one drain conductor parallel o the insulated wires; winding a metal foil tape on said insulated wires and said drain conductor collectively to form a shielding conductor; and covering an outer peripheral portion of said shielding conductor with a jacket, characterized in that said metal foil tape is wound in a condition that it is attached parallel to the insulated wires and the drain conductor.

4. A method of producing a parallel two-core type shielded electric wire as claimed in claim 3, characterized in that a hot-melt adhesive agent is applied to one side opposite to the conductor foil side of said metal foil tape and wherein said metal foil tape is bonded integrally to said jacket by heat produced when said jacket is used to cover the wire.

5. A cable formed with a plurality of parallel two-core type shielded electric wires bundled together into a multicore cable, the parallel two-core type shielded electric wire being formed such that at least one drain conductor is attached parallel to a pair of insulated wires arranged in parallel; a metal foil tape is wound on said insulated wires and said drain conductor collectively to form a shielding conductor; and an outer peripheral portion of said shielding conductor is covered with a jacket, characterized in that said metal foil tape is wound in a condition that it is attached parallel to the insulated wires and the drain conductor.

6. A cable as claimed in claim 5, characterized in that an adhesive agent is applied to one side opposite to the conductor foil side of said metal foil tape, so that said metal foil tape is made integral with said jacket by bonding.

7. A method of producing a cable formed with a plurality of parallel two-core type shielded electric wires bundled together into a multicore cable, the parallel two-core type shielded electric wire being formed such that at least one drain conductor is attached parallel to a pair of insulated wires arranged in parallel; a metal foil tape is wound on said insulated wires and said drain conductor collectively to form a shielding conductor; and an outer peripheral portion of said shielding conductor is covered with a jacket, characterized in that said metal foil tape is wound in a condition that it is attached parallel to the insulated wires and the drain conductor.

8. A method of producing a cable as claimed in claim 7, wherein a hot-melt adhesive agent is applied to one side opposite to a conductor foil side of said metal foil tape and wherein said metal foil tape is bonded integrally to said jacket by heat produced when said jacket is used to cover the wire.
